(19) United States
(12) Patent Application Publication
(10) Pub. No.: US 2009/0011925 A1
(43) Pub. Date: Jan. 8, 2009

(54) Method for producing catalytically active glass-ceramic materials, and glass-ceramics produced thereby

(76) Inventors: Larry Gordon Felix, Pelham, AL (US); David Morrissey Rue, Chicago, IL (US); Thomas Philip Seward, III, Elmira, NY (US); Logan Edwin Weast, Lombard, IL (US)

Correspondence Address: MARK E. FEJER;GAS TECHNOLOGY INSTITUTE, 1700 SOUTH MOUNT PROSPECT ROAD, DES PLAINES, IL, 60018, US

(21) Appl. No.: 11/825,462

(22) Filed: Jul. 6, 2007

(51) Int. Cl. B01J 23/00; B01J 21/10; B01J 23/02; B01J 23/06; B01J 23/10; B01J 23/28; B01J 23/34; B01J 23/42; B01J 23/46; B01J 23/50; B01J 23/52; B01J 23/72; B01J 23/745; B01J 23/755; B01J 29/00

(52) U.S. Cl. 502/60; 502/100; 502/240; 502/241; 502/242; 502/243; 502/244; 502/250; 502/251; 502/253; 502/256; 502/258; 502/259; 502/260; 502/261; 502/262; 502/263; 502/300; 502/302; 502/303; 502/304; 502/319; 502/324; 502/337; 502/338; 502/339; 502/340; 502/343; 502/344; 502/345; 502/347; 502/349; 502/350; 502/352; 502/355

(57) ABSTRACT

A catalytically active glass-ceramic and method for producing a catalytically active multi-phase glass-ceramic in which at least one catalyst precursor is mixed with a glass-ceramic precursor formulation to form a catalyst precursor/glass-ceramic precursor mixture. The catalyst precursor/glass-ceramic precursor mixture is then melted to form an amorphous glass material which, in turn, is devitrified to form a polycrystalline ceramic. The polycrystalline ceramic is then activated, forming a catalytically active multi-phase glass-ceramic.

The U.S. Government has a paid-up license in this invention and the right in limited circumstances to require the patent owner to license others on reasonable terms as provided for by the terms of Contract No. DE-FG36-04G014314 awarded by the U.S. Department of Energy.

### BACKGROUND OF THE INVENTION

1. Field of the Invention

This invention relates to a general method for creating robust, catalytically active materials suitable for use in a variety of applications. More particularly, this invention relates to a method for producing catalytically active glass-ceramics. The catalytically active glass-ceramics of this invention are engineered to resist attrition or to exhibit controlled rates of attrition in a variety of host environments. These applications include, but are not limited to, petroleum refining, Fischer-Tropsch syntheses, chemical synthesis and production, including the synthesis and production of pharmaceutical compounds, the production of plastics and foodstuffs, and catalysts that effect a chemical or physical change in combination with complexes of DNA-related molecules or living organisms, such as natural or genetically modified bacteria. This invention further relates to catalysts and catalytically active glass-ceramics suitable for use in gasification reactor vessels, in particular fluidized bed gasification reactor vessels, and combustion processes. Finally, this invention relates to a method and apparatus for reducing or eliminating tars, which are typically defined as organic compounds (generally hydrocarbons) having a molecular weight equal to or greater than 78, for example, benzene, and other undesirable volatile compounds produced during the gasification of various feedstocks including coal, biomass and waste materials and during the combustion of various fuels.

2. Description of Related Art

Few natural catalyst materials (e.g. dolomite) combine desirable catalytic and mechanical properties. Current synthesized catalysts improve upon these natural materials. Synthesized catalysts usually employ a high surface area substrate (e.g. alpha alumina) upon which a thin layer of catalytically active material is deposited (frequently by a method such as incipient wetness, vapor deposition or electrochemical deposition) and processed into a metallic oxide by calcination in air. After reduction in a hot, reducing atmosphere (e.g., H₂ at 600° C.), a catalytically active metallic surface is exposed. However, with this approach, the cost of production is increased due to the separate steps of chemical and physical processing. Because the construction of synthetic catalysts almost exclusively is executed in a layered approach, the finished product is vulnerable to deactivation by attrition of the catalytic surface and incorporation of catalytic surface material into the bulk of the support material. Because of the operating temperatures and possibility of attrition, many synthetic catalysts are not suitable for use in fluid-bed biomass gasifiers.

In general terms, gasification is a process whereby solid carbonaceous materials such as coal and biomass are converted into cleaner-burning gaseous fuels. Gasification is frequently carried out in a fluidized bed reactor, a reactor chamber comprising a fluidized bed support disposed within the reactor chamber and a fluidized bed material disposed on the fluidized bed support, which fluidized bed material comprises an inert component that is either fully inert or has low catalytic activity and a catalytically active component that is dispersed within or upon the inert component. During the gasification process, numerous by-products, including tars and other volatile materials, are also generated. Environmental regulations require that these by-products be treated or otherwise disposed of in an environmentally acceptable manner.

Catalysts are recognized as being essential for reducing or eliminating the tars that accompany the gasification of solid materials. Robust, efficient catalysts that are added to or comprise the bed material of fluidized bed gasifiers represent a significant development because they reduce the overall gasifier footprint by virtue of their incorporation into the gasifier, offer the possibility of substantially eliminating tar formation, and retain their activity in a harsh, chemically active environment. However, the development of in-bed catalysts has been slow because, to date, mineral geology has been relied upon for selection of the best materials for catalyst development. Thus, the ability to move away from earth mineralogy as the basis for identifying and selecting suitable catalyst substrates and catalytically active materials is a highly desirable objective, opening the door to the development of new catalyst formations from present waste materials, such as arc furnace dust, mold sands, various slags and mill scale.

Catalytically active materials employed for reducing or eliminating tars that are produced in the gasification of coal, biomass, or other materials, as well as for other applications, typically comprise two fundamental components, a catalytically active component and a base or substrate component for support of the catalytically active component. The base or substrate component is a material substantially physically and chemically inert to the environment in which it is to be used and is typically either a dense monolithic structure wherein the catalytically active component is deposited onto the surface of the structure or a porous structure wherein the catalytically active component is disposed on the surface of the structure and in the pores of the structure.

At the present time, most catalysts are prepared by depositing thin layers of catalytically active materials onto rigid, attrition-resistant substrates or by coating rigid, refractory monoliths (typically used in a self-supporting off-bed tar-cracker or specialized support structure for chemical synthesis). Typical substrates include α-alumina and zirconia. The method of applying a catalytically active layer onto an inert support varies, but generally two approaches are employed. The most common method, the incipient wetness or wet impregnation method, is typically accomplished by immersion of the substrate in an aqueous solution of a catalyst precursor (typically a metallic salt), resulting in a coated substrate, followed by heating of the coated substrate to convert the catalyst precursor to a catalytically active material, typically a metallic oxide. If the substrate is porous, a so-called three-dimensional or 3-D catalyst is created. If the surface is not porous, a two-dimensional or 2-D catalyst is created.

Another recently developed method for preparing catalysts uses thermal plasma chemical vapor deposition (TPCVD). This method is primarily used to produce monolithic two-dimensional catalysts and involves spraying a concentrated solution of a metallic salt through a plasma torch onto a suitable refractory substrate. Thus, the end product is a catalyst comprising an inert, rigid substrate with a thin, catalytically active outer layer. If the outer layer is damaged through attrition or fragmentation, overall catalytic activity is reduced. However, the advantage of this approach is that relatively large amounts of high surface area catalysts that incorporate precious metals can be produced with minimal amounts of these materials.

Two routes are generally available for employing catalysts to reduce or eliminate tars that are produced during the gasification of coal, biomass, or other materials. The first route is through the use of catalysts as described above disposed on the surface of otherwise inert monolithic substrates, which are disposed downstream of the gasification reactor vessel so that the gasification product gases are exposed to the catalysts. Typical of such catalysts are iron, nickel, cerium, ruthenium, and lanthanum. Catalytic materials have also been embedded into ceramic candle filters so that during high temperature gas particle separation, intimate gas-catalyst contact is assured.

The second route is through the direct introduction of suitably small fragments or beads of catalytic materials into the bed of a fluidized-bed gasifier. These catalytically active materials are either prepared by depositing a catalyst onto an inert, abrasion-resistant substrate, either monolithic or porous, or are available as naturally-occurring minerals that exhibit catalytic activity. Dolomite and olivine are examples of this type of naturally occurring mineral. When properly sized fragments of dolomite or olivine are added to the bed of a fluidized bed gasifier, they become intimately involved in the gasification process, achieve good contact with raw fuel gases and inhibit tar formation by cracking or reforming the tars as they are produced to generate lower molecular weight hydrocarbons and carbon. However, a long recognized problem with dolomite is that, within the bed of a gasifier, dolomite is rapidly calcined. Calcined dolomite is friable and, thus, tends to be quickly milled within the bed until its particle size becomes too small to be retained within the reactor vessel. This creates the need to replace the attrited catalyst and produces undesirable waste particulate material, aside from ash, that must be separated from the fuel gas. Thus, there is a need for durable catalytic materials that can withstand fluidized bed temperatures and resist fragmentation or, at a minimum, abrade at a slow, predictable rate so that fresh catalyst remains available.

As previously stated, in addition to dolomite, olivine is a naturally occurring catalytic material suitable for reducing tars in fuel gas. Olivine, which is a very hard, attrition-resistant, crystalline mineral which has a very high melting point (1760° C.) and which exhibits catalytic activity for tar removal with extended heat treatment in air at about 900° C., is actually a solid-solution mixture of two minerals—Fe-rich fayalite (Fe₂SiO₄) and Mg-rich forsterite (Mg₂SiO₄). Untreated, naturally occurring olivine exhibits less activity for tar removal than dolomite. However, it has been found that heating olivine for extended periods in air at about 900° C. appears to provide sufficient mobility to iron within the olivine so that it becomes enriched at the olivine-air interface. Free iron at the olivine-air interface is then transformed into an oxide by reacting with oxygen in the air and olivine that has been prepared in this manner has been found to exhibit enhanced catalytic activity for reducing tars in biomass-derived fuel gas. In addition, the catalytic activity of olivine may be further enhanced by calcining at 1100° C. olivine that has been treated with an aqueous solution of Ni(NO₃)₂.6H₂O (incipient wetness method) to a level of about 2.8 weight percent nickel content when dry. By virtue of this treatment, a very active olivine-based catalyst is produced that contains abundant quantities of NiO on the surface of finely divided olivine that has been sized to be in the range of about 250 μm to about 600 μm. Calcining at either higher or lower temperatures appears either to drive the NiO into the olivine or restrict adhesion of NiO to the surface of the olivine. This method of preparing a NiO-based catalyst on an olivine support is taught, for example, by International Patent Publication No. WO 01/89687 A1.

Glass-ceramics are polycrystalline materials obtained by the devitrification of amorphous glasses. More particularly, the term applies to a polycrystalline ceramic material produced by melting raw glass batch material to form an amorphous glass followed by heat treatment that renders the material at least 50% crystalline with the crystals distributed more or less uniformly throughout the body of the material. Crystallization generally occurs as the result of two steps carried out during the heat treatment—nucleation, i.e. formation of crystal nuclei, and crystal growth. Nucleation is achieved by bringing the temperature of the amorphous glass to a point above the glass transition temperature, i.e. the temperature below which the physical properties of amorphous materials vary in a manner similar to those of a crystalline phase (glassy state), and above which amorphous materials behave like liquids (rubbery state), and holding for a sufficient length of time for the spontaneous formation of homogeneous crystal nuclei throughout the bulk of the amorphous glass. Nucleation may further be promoted by the incorporation of a heterogeneous nucleating agent such as TiO₂ into the amorphous glass during the amorphous glass forming process. Crystal growth is achieved by raising the temperature further to a point approaching or exceeding the softening point of the nucleated amorphous glass so that crystals may grow from the previously formed nuclei. Primary crystal growth is the result of crystal formation at the expense of material in the bulk amorphous glass and secondary crystal growth is the result of crystals formed at the expense of smaller neighboring crystals. By controlling the crystal growth and limiting the amount of secondary growth, the resulting glass-ceramic typically will be at least 50% crystalline with the crystals formed being fine-grained and evenly distributed.

U.S. Pat. No. 2,920,971 to Stookey teaches the basic principles and methods for producing glass-ceramic materials. U.S. Pat. No. 6,300,262 to Beall teaches that it is possible to make a glass-ceramic in which the crystalline phase is forsterite. A composition and heat treatment were selected such that the material was 10-50% crystalline with the remaining portion consisting of a transparent glass, so as to maximize the material's optical properties. U.S. Pat. No. 6,300,263 to Merkel teaches the use of a low-expansion glass-ceramic which is based on the cordierite (Mg₂Al₄Si₅O₁₈) system and production of a glass which is first fritted in order to promote a surface-nucleated structure.

Several glasses and glass-ceramics within the lithium aluminosilicate family that include nickel, iron and cobalt as additional constituents are taught collectively by U.S. Pat. Nos. 3,962,514; 4,059,454; 4,083,709; 4,198,466; and 5,352,638. Some of these describe an “exuding” of metal oxides and reduction of the metal oxides to their metallic form. These patents further teach glass-ceramics having crystalline phases with microstructures in which the transition-metal compounds have an octahedral spinel (XY₂O₄) structure. U.S. Pat. No. 4,892,857 to Tennent teaches a method for creating a catalyst in which a mixture of materials—including glasses and glass-ceramics—are mixed with transition metal oxides and sintered together to form a monolithic article and reduced to form a material consisting of transition metals dispersed in a glass-ceramic. U.S. Pat. No. 3,949,109 to McBride teaches a method for creating a catalytic monolith by winding crystallizable glass fibers to form a cylinder with diamond shaped holes, and then heating the article to initiate the crystallization and turn the glass fibers into glass-ceramic. U.S. Pat. No. 5,488,023 to Gadkaree describes a method of creating a composite catalyst in which a catalytically active metal is finely dispersed through another primary material. In this case, the primary material is activated carbon. Finally, U.S. Patent Publication US 2005/0255995 teaches a general process of creating catalytically active materials in which metals and/or metal oxides are incorporated into the material by heating a base component until it softens and/or melts and then mixing a second catalytically active component with the base component. This method produces a composite material having a microstructure and properties substantially identical to the base component with which the method was started. Furthermore, although the method taught by this prior art application uses thermal and mechanical means to integrate the base and catalytically active components, the microstructure and dispersion achieved are similar to materials created using the chemical incipient wetness technique.

### SUMMARY OF THE INVENTION

It is one object of this invention to provide an efficient method for the production of catalytically active materials by integrating metals known to exhibit catalytic activity into glass-ceramics.

It is one object of this invention to provide a catalytically active material that is attrition resistant at its use temperature.

It is a further object of this invention to provide a catalytically active material in which the active catalytic elements are distributed throughout the volume of the material so that fresh catalyst material is exposed whenever the size of the material grains comprising the catalytically active material is comminuted.

It is yet a further object of this invention to provide a material whose catalytic activity can be regenerated by processing in a reducing atmosphere.

It is yet a further object of this invention to provide a catalytically active material for reducing or eliminating tars and other volatile compounds as they are generated in gasification and combustion processes.

The method of this invention involves the incorporation of catalyst precursor materials (e.g. NiO, CoO and FeO) within an inert, tough, refractory material (specifically a glass-ceramic), which is then processed as needed to concentrate the catalyst precursor component at the boundaries of crystals that comprise the glass-ceramic as microcrystalline metallic oxides and/or metallic silicates. When this new glass-ceramic material is exposed to a hot, reducing atmosphere (e.g., H₂ at 600° C.) the exposed catalyst precursor metallic oxides and/or metallic silicates are reduced to a metallic state and become active catalysts, resulting in a catalytically active glass-ceramic. When these mixtures are prepared, processed and made into finely divided granules (300-600 micrometer average diameter for use in a fluidized bed) or into self-supporting monoliths in accordance with the method of this invention, the resulting materials are indistinguishable in catalytic function from, or superior to, catalysts prepared by conventional techniques (e.g. by the method of incipient wetness). One application for which these materials are particularly suited is to replace the usual inert bed material in a fluid-bed gasifier with an attrition resistant, catalytically active material that can reduce or eliminate the tars produced in biomass gasification.

More particularly, this invention comprises a method for producing a catalytically active glass-ceramic in which at least one catalyst precursor is mixed with a glass-ceramic precursor formulation, thereby forming a catalyst precursor/glass-ceramic precursor mixture. This mixture is then melted to form an amorphous glass material. The amorphous glass material is devitrified in a controlled manner to form a polycrystalline ceramic, which is subsequently activated to produce a catalytically active glass-ceramic. In accordance with one embodiment of this invention, the catalyst precursor is a metal oxide which, upon exposure to a heated reducing atmosphere, is reduced to a metal. The glass-ceramic precursor formulation comprises any material or combination of materials suitable for forming an amorphous glass upon melting. The output of this method is a new class of glass-ceramic material, whereby when the amorphous glass material is devitrified and made into a crystalline material (the primary crystalline phase), a secondary phase (which may be a glass or a complex crystalline phase) is formed at the boundary surfaces of the major crystalline phases and grain boundaries that comprise the glass-ceramic material. Within this secondary phase, a preponderance of the catalytically active metals (as simple or complex compounds of metal oxides) are concentrated. When this new material is processed or fractured along the primary crystal boundaries to expose the secondary phase, and reduced using hydrogen (or another appropriate inert gas such as Ar or reactive reducing gas such as CO) at an elevated temperature (e.g. 600° C.), the simple or complex compounds of metal oxides concentrated in the secondary crystalline phase bounding the primary crystalline phase that are exposed to the hot reducing atmosphere are reduced to a catalytically active metallic phase. The desired product requires high melting point crystal phases, preferably occupying at least 50% of the material volume, in order to resist softening and agglomeration of the material at the high use temperatures typical of gasification.

Accordingly, the catalytically active glass-ceramic produced by the method of this invention comprises a primary crystalline phase which may contain a relatively small amount of catalytically active metal, at least one of a secondary crystalline phase and a secondary noncrystalline phase located at at least one boundary of the primary crystalline phase, and at least one catalytically active metal disposed in at least one of the secondary crystalline phase and the secondary noncrystalline phase.

### BRIEF DESCRIPTION OF THE DRAWINGS

These and other objects and features of this invention will be better under stood from the following detailed description taken in conjunction with the drawings wherein:

FIG. 1 shows three environmental scanning electron microscope (ESEM) micrographs of a glass-ceramic material containing 15% NiO: (a) after heat treatment at a magnification of 1.5×10³; (b) the material in (a) at a magnification of 10⁴; and (c) after reduction in hydrogen to create Ni metal on exposed surfaces at a magnification of 10⁴;

FIG. 2 shows energy-dispersive X-ray spectroscopy (EDS) spectra of one of (a) the dark background and (b) the light regions near the center of FIG. 1(a) showing Ni enrichment in the lighter areas;

FIG. 3 is an ESEM micrograph showing the lamellar structure of Ni-rich Liebenbergite crystals that are layered around the lithium aluminosilicate primary phase at crystal grain boundaries in a heat treated glass-ceramic having 10 wt % NiO;

FIG. 4 is a diagram showing naphthalene decomposition activity using a glass-ceramic in accordance with one embodiment of this invention;

FIG. 5 is a diagram showing CO production during naphthalene decomposition using a glass-ceramic in accordance with one embodiment of this invention;

FIG. 6 is a diagram showing CO₂ reduction during naphthalene decomposition using a glass-ceramic in accordance with one embodiment of this invention;

FIG. 7 is a diagram showing CH₄ conversion during naphthalene decomposition using a glass-ceramic in accordance with one embodiment of this invention;

FIG. 8 is a diagram showing naphthalene decomposing activity of a packed bed of 400 μm alumina beads;

FIG. 9 is a diagram showing naphthalene decomposing activity of a glass-ceramic catalyst in accordance with one embodiment of this invention; and

FIG. 10 is a diagram showing naphthalene decomposing activity of a glass-ceramic catalyst in accordance with another embodiment of this invention.

### DETAILED DESCRIPTION OF THE PRESENTLY PREFERRED EMBODIMENTS

As used herein, the term “primary crystalline phase” refers to that portion of a catalytically active glass-ceramic in accordance with this invention comprising greater than 50% by volume of the glass-ceramic. As used herein, the term “secondary crystalline phase” refers to a crystalline portion of a catalytically active glass-ceramic in accordance with one embodiment of this invention comprising less than 50% by volume of the glass-ceramic. As used herein, the term “secondary noncrystalline phase” refers to a noncrystalline portion of a catalytically active glass-ceramic in accordance with one embodiment of this invention comprising less than 50% by volume of the glass-ceramic. As used herein, the term “catalyst precursor” refers to a material which is converted to a catalyst material after processing. For example, in accordance with one embodiment of this invention, metal oxides are catalyst precursors which are converted to catalysts upon exposure to a reducing atmosphere. In accordance with another embodiment of this invention, the catalyst precursors may be metal silicates. As used herein, the term “glass-ceramic precursor formulation” refers to a combination of materials (raw glass batch) suitable for melting to form amorphous glass. As used herein, the term “glass-ceramic precursor material” refers to the amorphous glass produced by melting the raw glass batch. In accordance with one preferred embodiment of this invention, the glass-ceramic precursor material comprises silicates, e.g. lithium silicate and aluminosilicates. In accordance with a particularly preferred embodiment, the glass-ceramic precursor material comprises lithium aluminosilicate.

The method of this invention comprises combining catalyst precursors as oxides within the raw batch material for producing silicate, melting all of the components in a high temperature glass melting furnace, cooling the melt to form a conventional, amorphous glass containing few, if any, crystals, and heat treating the amorphous glass to crystallize it into a fine-grained glass-ceramic. These operations are all performed in an oxidizing atmosphere, typically air. Thereafter, the glass-ceramic is heat treated in a reducing or chemically inert environment, whereby the catalyst precursor oxides are converted to elemental catalyst materials. In accordance with one embodiment of this invention, the amorphous glass comprises a nucleating agent which ensures a prolific nucleation of the crystalline phase or phases of the glass-ceramic. Suitable nucleating agents include TiO₂ and ZrO₂.

The end product of the method of this invention is a catalytically active glass-ceramic comprising a primary crystalline phase, at least one of a secondary crystalline phase and a secondary noncrystalline phase located at at least one boundary of the primary crystalline phase, and at least one catalytically active metal disposed in the primary crystalline phase, and in at least one of the secondary crystalline phase and the secondary noncrystalline phase. In accordance with one embodiment of this invention, the at least one catalytically active metal is selected from the group consisting of Al, Ag, Au, Ca, Co, Cr, Cu, Eu, Fe, Gd, Ir, La, Mg, Mn, Ni, Pr, Pt, Ru, Rh, Sn, Zn, and alloys and mixtures thereof. In accordance with one embodiment of this invention, the at least one catalytically active metal comprises at least about 3% by weight of the glass-ceramic. In accordance with one embodiment of this invention, the glass-ceramic has a crystal content of at least about 10% by volume. The majority of the crystals forming the glass-ceramic preferably have a crystal size less than about 10 microns. In accordance with one preferred embodiment of this invention, the glass-ceramic is an aluminosilicate having a composition comprising a range by weight of about 35-75% SiO₂, 12-25% Al₂O₃, 5-30% of at least one of NiO, CoO, and FeO, 0-10% Li₂O, 0-10% MgO, 0-5% CaO, 0-3% B₂O₃, 0-3% ZnO, 0-15% CeO₂, and 0-5% of at least one of TiO₂ and ZrO₂.

Many commercial glass-ceramics may be employed as base components of the catalytically active materials of this invention, but preferred glass-ceramics are those that produce a material stable against melting at the high use temperatures of the chemical reactors. Examples of glass-ceramics that are stable against melting at the high use temperatures of the chemical reactors are given in Table 1. The lithium-aluminosilicate glass-ceramics are known for their very low coefficients of thermal expansion, and the magnesium aluminosilicate glass-ceramics are known for their good mechanical, thermal and electrical properties. The lithium-aluminosilicate glass-ceramic compositions are generally based around the composition of the mineral β-spodumene (Keatite), with useful compositions varying in the ratio of the primary ingredients Li₂O:Al₂O₃:SiO₂ from 1:1:4 to 1:1:10 (on a molar basis).

TABLE 1
Glass-ceramics Stable at High Temperatures

| | System Number | | | | |
|---|---|---|---|---|---|
| | 1 | 2 | 3 | 4 | 5 |
| Glass-Ceramic | Li₂O—Al₂O₃—SiO₂ | MgO—Al₂O3—SiO₂ | Na₂O—Al₂O3—SiO₂ | Li₂O—SiO₂ | CaO—MgO—Al₂O₃—SiO₂ |
| System | | | | | |
| SiO₂ | 70 | 56 | 43 | 80 | 56 |
| Al₂O₃ | 18 | 20 | 30 | 4 | 8 |
| Li₂O | 3 | | | 10 | |
| MgO | 3 | 15 | | | 2 |
| ZnO | 1 | | | | 2 |
| K₂O | | | | 4 | 1 |
| Na₂O | | | 14 | 2 | 5 |
| TiO₂ | 5 | 9 | 7 | | |
| CaO | | | | | 25 |
| BaO | | | 6 | | |
| MnO | | | | | 1 |

All percentages are Wt % unless otherwise noted

To these glass-ceramics, 5-30 wt % transition metal oxides, including, but not limited to: cobalt, iron, nickel, palladium, platinum, rhodium, ruthenium, molybdenum, vanadium, and cerium, are then added by way of the method of this invention, while either keeping the glass-ceramic stoichiometry constant, or by substituting the metal oxide(s) for all or part of one or more of the glass-ceramic components. Suitable glass-ceramics are not limited to the specific compositions listed in Table 1, but can also vary in composition as necessary to stabilize the glass phase, the ceramic product, or the metal oxides during one or more steps in the production of the glass-ceramic catalytic material. For this invention, cobalt, iron, and nickel are the preferred metal oxides for use due to their adequate catalytic activity at significantly reduced cost relative to the catalytically active precious metals. In accordance with one embodiment of this invention, a sufficient amount of cerium oxide is provided with the other metal oxide component(s) to promote the tar reforming and anti-coking properties of the catalyst. Ideally, the catalytically active species will be relatively insoluble in the primary crystallizing phases such that they are concentrated at the grain boundaries between the primary crystallites.

### EXAMPLE

Catalytic materials within the Li₂O —Al₂O₃—SiO₂ system have been prepared, with compositions shown in Table 2, below. These compositions were treated to demonstrate that when a fractured surface is exposed to a reducing atmosphere the desired metallic phase will develop on the material surface. Samples of these compositions were heat-treated for 60 minutes at 730° C. to develop crystal nuclei, followed by a heat treatment of 30 minutes at 1000° C. to complete growth of the crystalline phase (Table 3). While this heat treatment schedule is adequate for development of the crystalline phase within small samples of material (<50 g pieces), for larger samples or for a continuous production line, heat treatment may require longer periods of time at a range of temperatures. Heat treatments for similar glass-ceramic materials in the lithium-aluminosilicate system are often carried out for 1-5 hours at 700-800° C. for the nucleation step and 1-20 hours at 950-1100° C. to grow the crystal phase on the nuclei.

TABLE 2
Experimental Glass-ceramic Compositions

| | 4-A | 4-C | 4-D | 4-F | 4-G | 4-H | 4-I | 5-A | 5-B | 5-C | 5-D | 5-E | 5-F | 6-A | 6-B |
|---|---|---|---|---|---|---|---|---|---|---|---|---|---|---|---|
| SiO₂ | 63.50 | 57.15 | 53.98 | 63.50 | 63.50 | 63.50 | 50.80 | 53.98 | 50.80 | 53.98 | 53.98 | 50.80 | 53.98 | 53.03 | 46.63 |
| CaO | 2.00 | 1.80 | 1.70 | 2.00 | 2.00 | 2.00 | 1.60 | 1.70 | 1.60 | 1.70 | 1.70 | 1.60 | 1.70 | — | — |
| Li₂O | 3.50 | 3.15 | 2.98 | 3.50 | 3.50 | 3.50 | 2.80 | 2.98 | 2.80 | 2.98 | 2.98 | 2.80 | 2.98 | 3.18 | 3.06 |
| CoO | — | — | — | — | — | — | — | 5.00 | 10.00 | 10.00 | — | 5.00 | 5.00 | — | — |
| NiO | — | 10.00 | 15.00 | 6.45 | 10.00 | 15.00 | 20.00 | 10.00 | 10.00 | 5.00 | 10.00 | 10.00 | 5.00 | 11.37 | 10.94 |
| Al₂O₃ | 20.00 | 18.00 | 17.00 | 20.00 | 15.00 | 10.00 | 16.00 | 17.00 | 16.00 | 17.00 | 17.00 | 16.00 | 17.00 | 21.72 | 20.90 |
| B₂O₃ | 2.75 | 2.48 | 2.34 | 2.75 | 2.00 | 2.00 | 2.20 | 2.34 | 2.20 | 2.34 | 2.34 | 2.20 | 2.34 | 2.12 | 2.04 |
| MgO | 1.80 | 1.62 | 1.53 | 1.80 | 1.80 | 1.80 | 1.44 | 1.53 | 1.44 | 1.53 | 1.53 | 1.44 | 1.53 | 3.68 | 4.72 |
| TiO₂ | 4.25 | 3.83 | 3.61 | — | — | | 3.40 | 3.61 | 3.40 | 3.61 | 3.61 | 3.40 | 3.61 | — | — |
| ZnO | 2.20 | 1.98 | 1.87 | — | 2.20 | 2.20 | 1.76 | 1.87 | 1.76 | 1.87 | 1.87 | 1.76 | 1.87 | 2.48 | 2.38 |
| Fe₂O₃ | — | — | — | — | — | — | — | — | — | — | 5.00 | 5.00 | 5.00 | 2.42 | 9.32 |

TABLE 3
Heat treatments, comments, and crystal phases identified by XRD
analysis

| Sample | Heat treatment | Primary Phase | Secondary Phase(s) |
|---|---|---|---|
| 4-D | 730° C. - 30 min | Lithium Aluminum Silicate | Magnesium Silicate |
| | 1000° C. - 60 min | | Ni5TiO4(BO3)2 |
| 4-D | 800° C. - 120 min | — | — |
| 4-G | 730° C. - 30 min | (Li,Mg,Zn)— Aluminum Silicate | Nickel Magnesium Silicate |
| | 1000° C. - 60 min | | |
| 4-G | 800° C. - 120 min | — | — |
| 5-A | 730° C. - 30 min | (Li,Mg,Zn)— Aluminum Silicate | Cobalt nickel zinc silicate |
| | 1000° C. - 60 min | | Magnesium silicate |
| 5-F | 730° C. - 30 min | Lithium Aluminum Silicate | Iron (III) Nickel Oxide |
| | 1000° C. - 60 min | | Zinc (Al—Fe) Oxide |
| 6-A | 730° C. - 30 min | Lithium Aluminum Silicate | Magnesium Nickel Silicate |
| | 1000° C. - 60 min | | zinc dialuminum oxide |
| | | | iron dialuminum oxide |
| 6-B | 730° C. - 30 min | (Li,Mg,Zn)— Aluminum Silicate | forsterite (synthetic) |
| | 1000° C. - 60 min | | spinel (ferrian) |

Environmental scanning electron microscope (ESEM) imaging of the glass-ceramic compositions shows that the materials are nearly completely crystalline, with impinging grains and small regions of secondary crystals and/or residual glass at the grain boundaries. Catalytic testing of sample 4-D has shown that the treated surface is highly active as a catalyst for the reforming of organic tars formed in biomass gasification processes. Below, we present documentation of this reduction to practice.

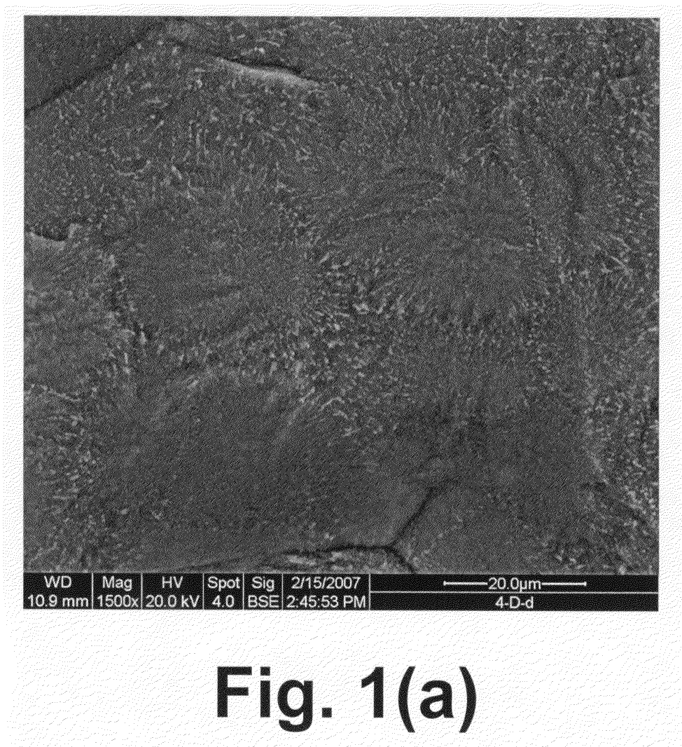

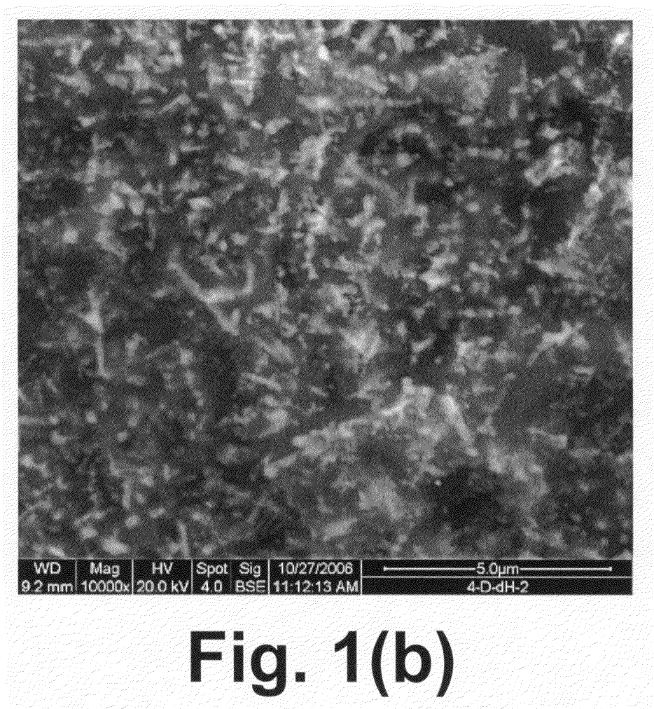

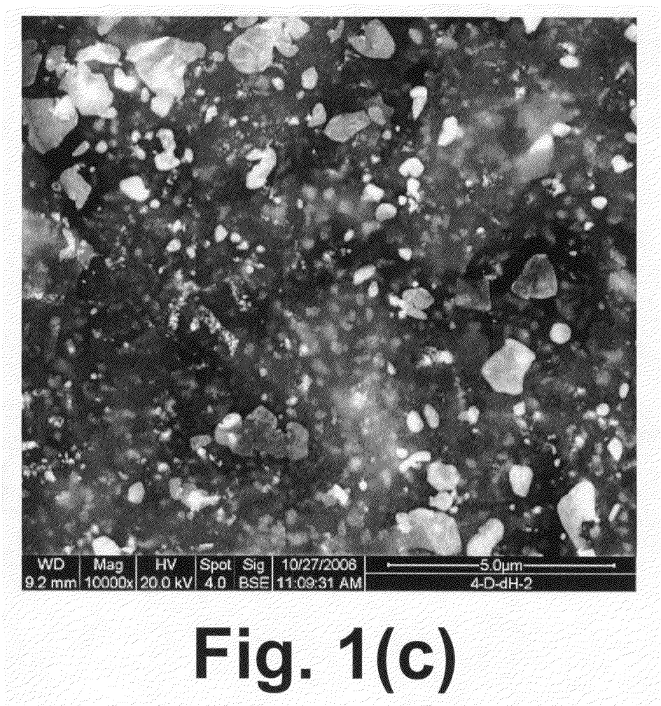

FIG. 1 shows three environmental scanning electron microscope (ESEM) micrographs, labeled a, b, and c, of the glassy phase of one glass-ceramic formulation that contains 15 wt % NiO (a), the same material shown after heat treating to produce a microcrystalline glass-ceramic (b), and a sample of the glass-ceramic after being reduced in a hydrogen atmosphere to create metallic nickel on areas of the sample exposed to the hydrogen. FIG. 1(a) shows the heat treated glass-ceramic at a magnification of 1.5×10³; FIG. 1(b) shows the same surface at a magnification of 10⁴. The feathery inclusions within the cerammed material have been positively identified as NiO inclusions at the grain boundaries of the micro-crystalline ceramic. Finally, FIG. 1(c) shows the surface of the heat treated glass-ceramic at a magnification of 10⁴ after being reduced under hydrogen. The bright features in this micrograph have been positively identified as Ni metal formed from reduction of the NiO inclusions seen in FIG. 1(b). Measurements suggest that ˜16% of the exposed surface seen in FIG. 1(c) is Ni metal.

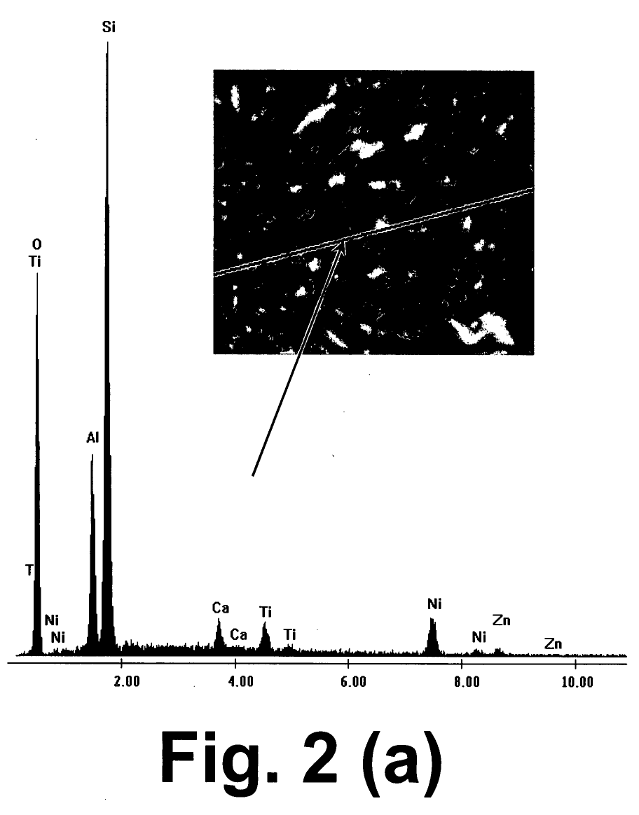

FIG. 2 shows energy-dispersive X-ray spectroscopy (EDS) spectra of the heat-treated region shown in FIG. 1(a). FIG. 2(a) shows an enlarged section of FIG. 1(a) and an EDS spectrum of the dark background area near the center of the line scan shown in the enlarged portion of FIG. 1(a) at the point of the arrow in FIG. 2(a) and FIG. 2(b) presents an enlarged section of FIG. 1(a) and an EDS spectrum of the light, filamentary regions near the center of the line scan shown in the enlarged portion of FIG. 1(b) at the point of the arrow in FIG. 2(b). These spectra clearly show that nickel is enriched in the light, filamentary regions in FIG. 1(a). This allows identification of such areas as crystal boundaries where NiO is aggregated during ceramming.

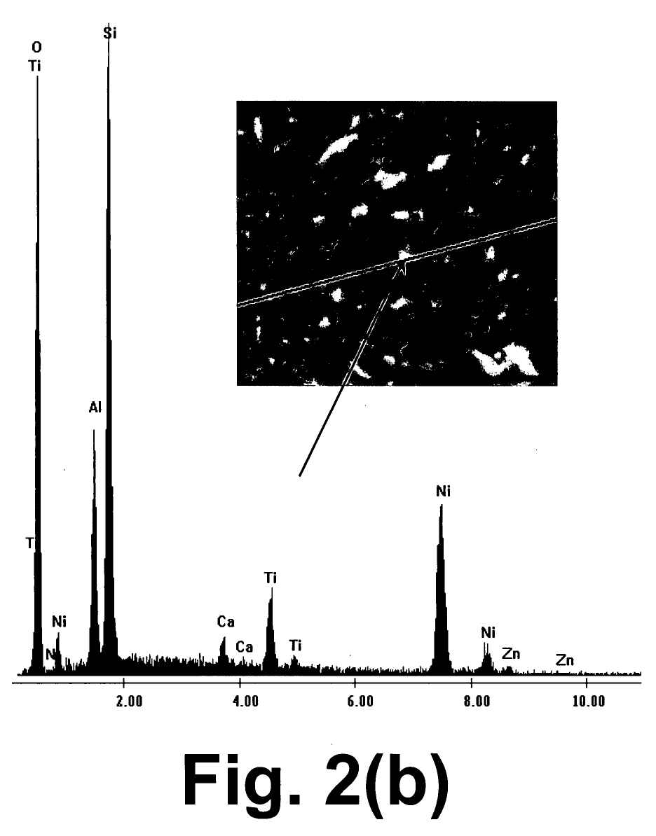

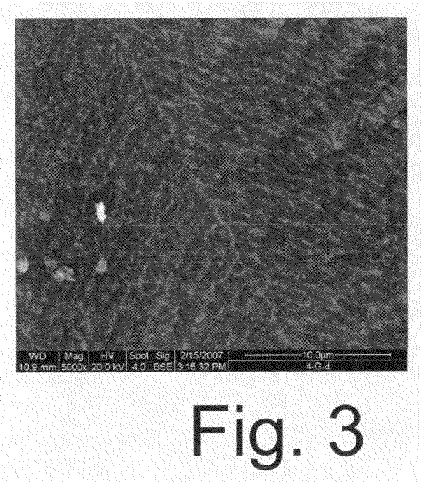

FIG. 3 shows another potentially promising feature of these glass-ceramic materials. In this figure, taken from a heat-treated sample of formulation 4-G, the leaf-like or feather-like pattern is referred to as a lamellar microstructure. Ceramics with this structure frequently show particularly good fracture toughness due to the lamellar layering of the microcrystals. This sample is of particular interest because the secondary phase (Liebenbergite) is similar in structure to mineral olivine, but with substitution of Ni for some Fe in the olivine structure. Note, NiO was not observed in this crystal phase, but rather nickel-rich Liebenbergite crystals were detected and these crystals are layered around the lithium aluminosilicate primary phase. We believe that the nickel in this nickel magnesium silicate (Liebenbergite) phase is what is reduced to the nickel metal at the surface after prolonged exposure to a hot, reducing atmosphere (e.g., H₂ at 600° C.).

The materials prepared by this approach are unique from another perspective: as opposed to catalytically active materials created by conventional methods, e.g. incipient wetness, the method of this invention distributes catalytically active metals (e.g. Fe, Ni, and Co) throughout the catalyst substrate in a remarkably even manner. Because these metals all exhibit mobility within an olivine structure, a structure very similar to that found in these glass-ceramics, they may offer the capability of refreshing spent or deactivated catalysts at their surface. One potential downside of using catalysts made of these materials for tar decomposition is that particles of these catalysts may not exhibit even moderate surface areas by catalytic materials standards. However, even with average surface areas on the order of 0.05-0.1 m²/gm, within a fluid bed gasifier, the aggregated surface area of many 250 micrometer diameter particles is not small. Finally, a small surface area is a requirement for Fischer-Tropsch catalysts, as low surface areas are best suited to the exothermic nature of Fischer-Tropsch synthesis.

### EXAMPLE

Approximately 50 grams of a glass-ceramic having composition 4-D were crushed and sieved to select particles ranging from 100 microns to 400 microns and these fragments were placed in a 0.75 in. 316 stainless steel tube that was located within a tube furnace. The tube furnace was held at 600° C. overnight while a low flow (˜10 cc/min) hydrogen gas was directed through the tube.

This material was tested in a packed-bed configuration with simulated syngas in a 1″ quartz reactor at a variety of temperatures. The experiments were performed at atmospheric pressure and temperatures of 650° C., 750° C., 800° C., 850° C. and 900° C. The feed gas flow rate was maintained at 1199 cc/min (room temperature) and consisted of 16% H₂, 8% CO, 12% CO₂, 4% CH₄, 16% H₂O (steam), 44% N₂, and 20 cc/min of N₂ as a naphthalene carrier gas. Twenty grams of crushed and reduced sample 4-D was loaded into the reactor with an L/D=1, and during testing a space velocity of 5500 hr⁻¹ was maintained. The packed-bed condition was confirmed both by observation of the loaded reactor at 800° C., and by monitoring the pressure differential across the reactor during the experiment. Naphthalene vapor generation averaged 3.87 mg/L during the experiment. All gas concentration measurements were determined with an Industrial Monitor and Control Corporation (IMACC) Fourier Transform Infrared Spectrometer (FTIR). This device had been thoroughly tested and calibrated just before this test series was carried out.

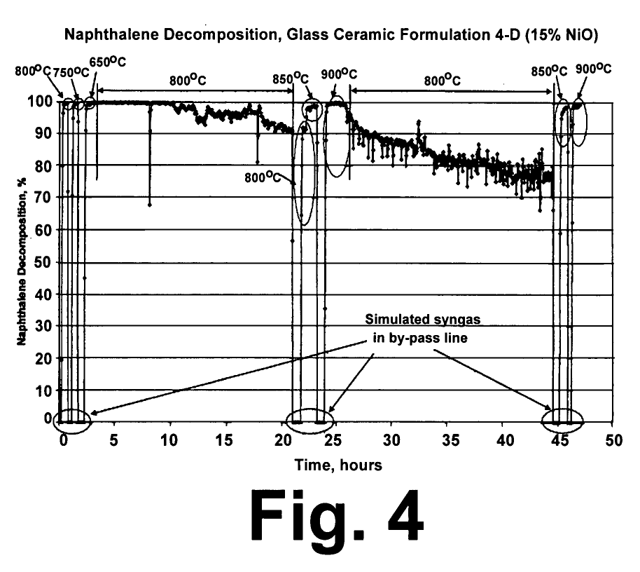

FIG. 4 shows naphthalene decomposing activity of the 4-D material during 47 hours of run-time at a variety of reactor temperatures. The simulated syngas initially flowed through a by-pass line to confirm the stability of the gas composition before directing the simulated syngas feed into the reactor. This test was repeated periodically to assure that the inlet conditions remained constant. Testing was performed at a variety of reactor temperatures as shown in FIG. 4 to identify the naphthalene decomposing activity of the 4-D material. The results indicated that 100% of the naphthalene in the syngas was decomposed during the first 11 hours of exposure without regard to reactor temperature. After that time, the activity of the 4-D material started to deteriorate, most likely due to the deposition of carbon/soot produced by the decomposition of the naphthalene. After 21 hours of testing, the syngas mixture was diverted to the by-pass line for 30 minutes to verify the stability of the syngas mixture entering the reactor. The feed gas was then switched back to the reactor to continue the experiment at 800° C. The same level of naphthalene conversion (˜91%) observed before and after verifying the stability of the incoming syngas mixture. When the reactor temperature was raised to 850 and 900° C., 98-100% naphthalene decomposition was observed. This behavior was observed a second time at the end of the experiment. It could be due to the burn-out of carbon/soot at high temperature, which exposes clean, catalytically active surfaces. During the second over-night experiment at 800° C., naphthalene decomposition dropped to 78%. This was probably due to the accumulation of carbon/soot on surfaces of the catalytic material, since it was observed that when the reactor temperature was increased the amount of naphthalene decomposition increased dramatically.

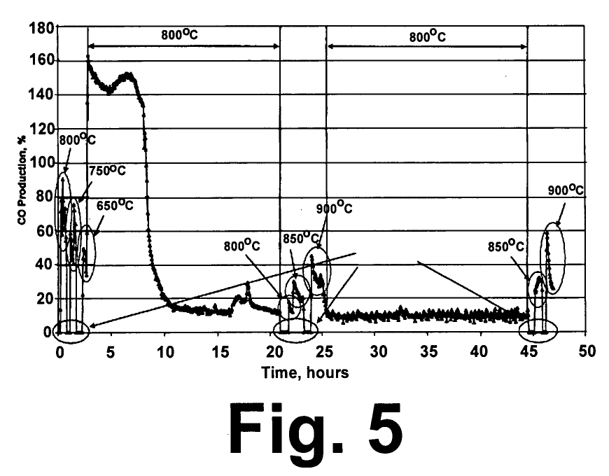

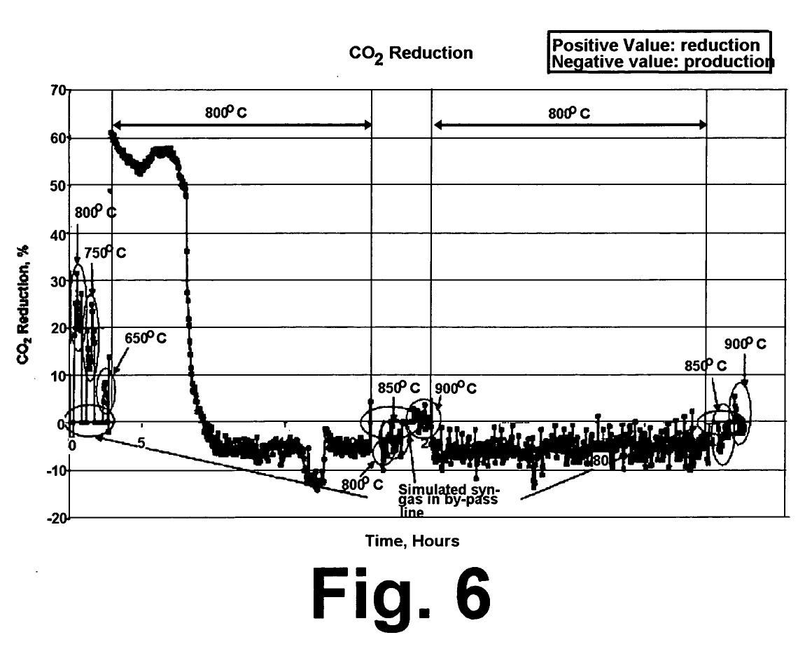

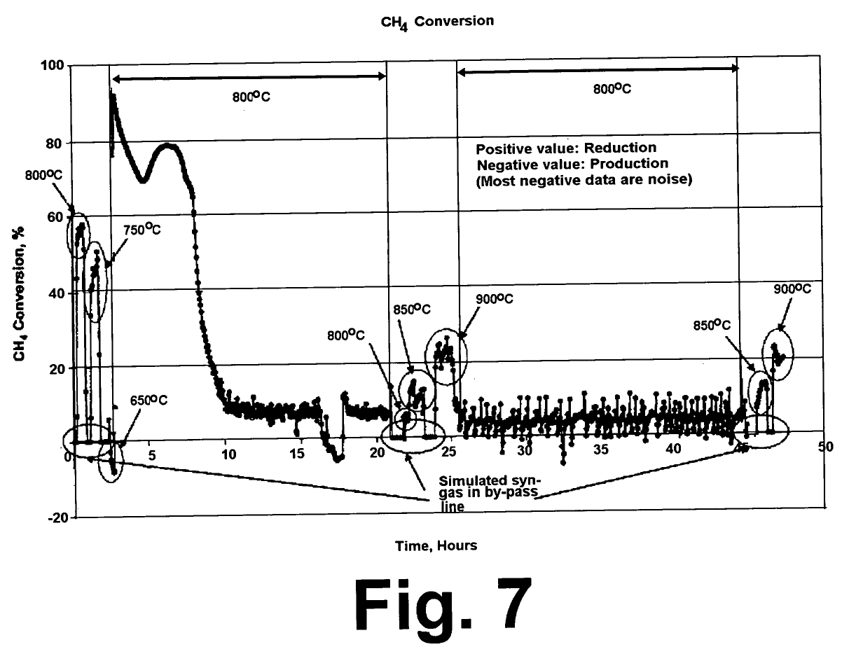

FIGS. 5, 6 and 7 present the changes measured in CO, CO₂ and CH₄ throughout the course of the experiment. They show similar variations throughout the test due to the following major reactions of catalysis:

pCₙHₓ→qCₘH_{y}+rH₂ (1) Thermal Cracking

CₙHₓ+nH₂O→(n+x/2)H₂+nCO (2) Steam reforming

CₙHₓ+nCO₂→(x/2)H₂+2nCO (3) Dry reforming

CₙHₓ→nC+(x/2)H₂ (4) Carbon formation

CO₂+H₂→CO+H₂O (5) Water gas shift reaction

The significant decrease of CO, CO₂ and CH₄ detection around 10 hours of testing corresponds to the lessening of naphthalene decomposition shown for the same period in FIG. 4. Note that from this point on, the concentrations of CO, CO₂ and CH₄ never returned to their initial levels. We observed only 10% to 20% increases at high temperature. These results suggest that carbon/soot deposits were not completely removed by increasing the temperature of the reactor, and may also mean that the reforming reactions mostly depend on the exposed surface area of sample. In other words, the formation of CO and H₂ is indirectly affected by the accumulation of carbon.

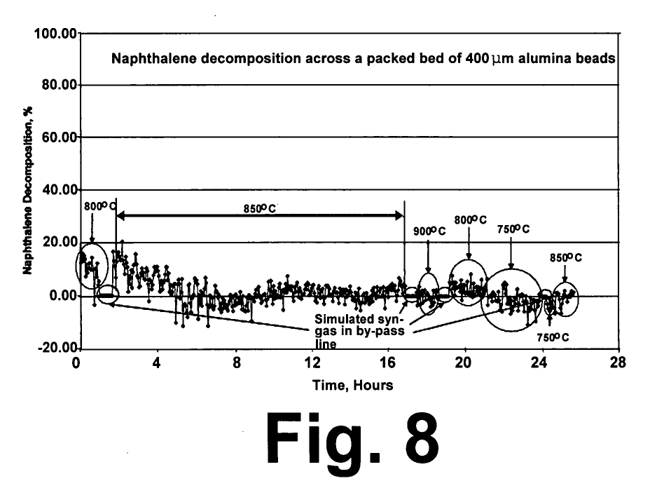

In order to confirm the catalytic activity of the 4-D glass-ceramic formulation, baseline testing with the same syngas composition employed above was performed with no catalytically active material disposed within the reactor. Alumina, which is well-known to possess no catalytic activity, is a baseline material that was used to conduct the same experiment as that carried out with the 4-D material. FIG. 8 shows the naphthalene decomposition associated with a packed bed of 400 mm alumina spheres throughout the 26 hours of this baseline experiment. The test conditions were the same as that employed in testing the 4-D material, except 5.3 mg/L of naphthalene was fed which is equivalent to 1000 ppm. This figure shows minor naphthalene decomposition in the first 3 hours of the experiment, dropping to zero decomposition after 6 hours. These early results could actually be considered as noise. After the first 6 hours, no naphthalene decomposition was observed and reactor temperature had no effect on naphthalene decomposition. Additional baseline testing was performed with an empty reactor and with syngas formulations that only contained naphthalene, steam, and N₂. These tests further confirmed that the naphthalene decomposition observed with the 4-D glass-ceramic catalyst was caused by the glass-ceramic catalyst and not by the reactor.

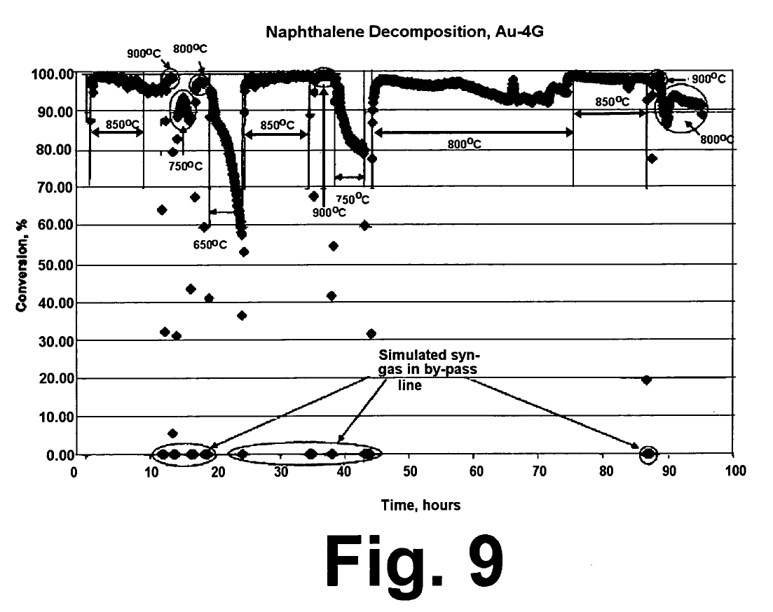

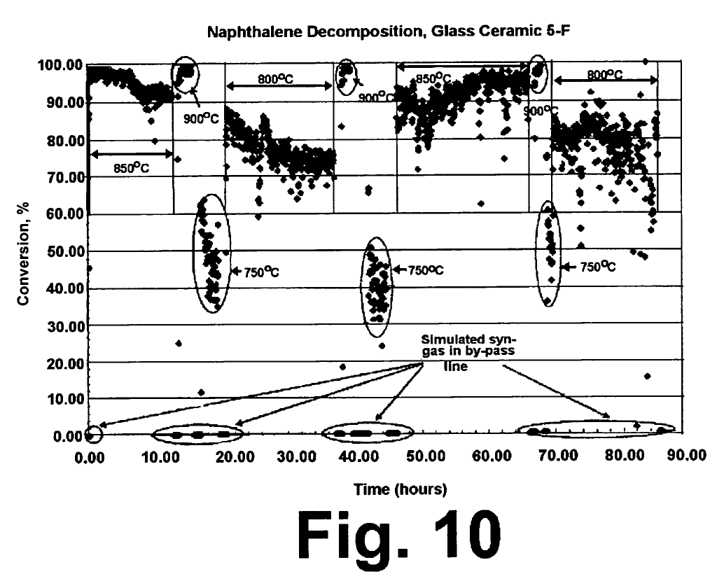

Additional catalytic testing of glass-ceramic materials 4-G and 5-F was carried out with results similar to those of material 4-D, showing that many formulations within the family of glass-ceramic materials that have been developed are promising, though some optimization of the compositions can still be accomplished to increase the overall catalytic performance. Napthalene decomposing activity of these additional glass-ceramic materials is illustrated in FIGS. 9 and 10.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A method for producing a catalytically active glass-ceramic comprising the steps of:
mixing at least one catalyst precursor with a glass-ceramic precursor formulation, forming a catalyst precursor/glass-ceramic precursor mixture;
melting said catalyst precursor/glass-ceramic precursor mixture, forming an amorphous glass material;
devitrifying said amorphous glass material, forming a polycrystalline ceramic; and
activating said polycrystalline ceramic, forming a catalytically active glass-ceramic.

2. A method in accordance with claim 1, wherein said at least one catalyst precursor is selected from the group consisting of metal oxides, metal silicates, and mixtures thereof.

3. A method in accordance with claim 2, wherein said polycrystalline ceramic is activated by heat treating said polycrystalline ceramic in one of a chemically reducing atmosphere and a non-oxidizing atmosphere, converting said catalyst precursor to metal.

4. A method in accordance with claim 2, wherein said catalyst precursor comprises a metal selected from the group consisting of Al, Ag, Au, Ca, Co, Cr, Cu, Eu, Fe, Gd, Ir, La, Mg, Mn, Ni, Pr, Pt, Ru, Rh, Sn, Zn, and alloys and mixtures thereof.

5. A method in accordance with claim 1, wherein said amorphous glass material comprises at least one nucleating agent.

6. A method in accordance with claim 1, wherein said amorphous glass material is devitrified by heat treating said amorphous glass material at temperatures in a range of about 600° C. to about 1200° C.

7. A method in accordance with claim 3, wherein said one of said reducing atmosphere and said non-oxidizing atmosphere comprises at least one of H₂ and CO.

8. A method in accordance with claim 1, wherein said amorphous glass material and said polycrystalline ceramic are formed in an oxidizing atmosphere.

9. A method in accordance with claim 1, wherein said catalytically active glass-ceramic is in a form of fibers.

10. A method in accordance with claim 9, wherein said fibers are formed into a monolithic catalytically active structure.

11. A method in accordance with claim 1, wherein said glass-ceramic comprises at least one aluminosilicate material.

12. A method in accordance with claim 11, wherein said at least one aluminosilicate material is selected from the group consisting of lithium aluminosilicate and magnesium aluminosilicate.

13. A method in accordance with claim 4, wherein said catalyst precursor comprises cerium oxide.

14. A catalytically active glass-ceramic comprising:
a primary crystalline phase;
at least one of a secondary crystalline phase and a secondary noncrystalline phase located at at least one boundary of said primary crystalline phase; and
at least one catalytically active metal disposed in said primary crystalline phase and in said at least one of said secondary crystalline phase and said secondary noncrystalline phase.

15. A catalytically active glass-ceramic in accordance with claim 14, wherein said at least one catalytically active metal is selected from the group consisting of Al, Ag, Au, Ca, Co, Cr, Cu, Eu, Fe, Gd, Ir, La, Mg, Mn, Ni, Pr, Pt, Ru, Rh, Sn, Zn, and alloys and mixtures thereof.

16. A catalytically active glass-ceramic in accordance with claim 15, wherein said at least one catalytically active metal comprises at least about 3% by weight of said glass-ceramic.

17. A catalytically active glass-ceramic in accordance with claim 14, wherein said glass-ceramic has a crystal content of at least about 10% by volume.

18. A catalytically active glass-ceramic in accordance with claim 14, wherein at least one of said primary crystalline phase and said secondary crystalline phase comprises a majority of crystals having a crystal size less than about 10 microns.

19. A catalytically active glass-ceramic in accordance with claim 14, wherein said glass-ceramic is an aluminosilicate having a composition comprising a range by weight of about 35-75% SiO₂, 12-25% Al₂O₃, 5-30% of at least one of NiO, CoO, and FeO, 0-10% Li₂O, 0-10% MgO, 0-5% CaO, 0-3% B₂O₃, 0-3% ZnO, 0-15% CeO₂, and 0-5% of at least one of TiO₂ and ZrO₂.

20. A catalytically active glass-ceramic produced by a method comprising the steps of:
mixing at least one catalyst precursor with a glass-ceramic precursor formulation, forming a catalyst precursor/glass-ceramic precursor mixture;
melting said catalyst precursor/glass-ceramic precursor mixture, forming an amorphous glass material;
devitrifying said amorphous glass material, forming a polycrystalline ceramic; and
activating said polycrystalline ceramic, forming said catalytically active glass-ceramic.

21. A catalytically active glass-ceramic produced in accordance with claim 20, wherein said devitrifying comprises a first heat treating stage during which nucleation primarily occurs and a second heat treating stage during which crystal growth primarily occurs.

22. A catalytically active glass-ceramic produced in accordance with claim 20, wherein said glass-ceramic precursor formulation comprises a nucleating agent.

23. A catalytically active glass-ceramic produced in accordance with claim 22, wherein said nucleating agent is selected from the group consisting of TiO₂, ZrO₂ and mixtures thereof.

24. A catalytically active glass-ceramic produced in accordance with claim 20, wherein said catalyst precursor is selected from the group consisting of metal oxides, metal silicates, and mixtures thereof.

25. A catalytically active glass-ceramic produced in accordance with claim 24, wherein said polycrystalline ceramic is activated by heat treating said polycrystalline ceramic in one of a reducing atmosphere and a non-oxidizing atmosphere, thereby converting said catalyst precursor to metal.

26. A catalytically active glass-ceramic produced in accordance with claim 24, wherein said catalyst precursor comprises a metal selected from the group consisting of Al, Ag, Au, Ca, Co, Cr, Cu, Eu, Fe, Gd, Ir, La, Mg, Mn, Ni, Pr, Pt, Ru, Rh, Sn, Zn, and alloys and mixtures thereof.

27. A catalytically active glass-ceramic produced in accordance with claim 20, wherein said amorphous glass material is devitrified at temperatures in a range of about 600° C. to about 1200° C.

28. A catalytically active glass-ceramic produced in accordance with claim 25, wherein said one of said reducing atmosphere and said non-oxidizing atmosphere comprises at least one of H₂ and CO.

29. A catalytically active glass-ceramic produced in accordance with claim 20, wherein said melting and devitrifying are carried out in an oxidizing atmosphere.

30. A catalytically active glass-ceramic produced in accordance with claim 20, wherein said catalytically active glass-ceramic is in a form of fibers.

31. A catalytically active glass-ceramic produced in accordance with claim 30, wherein said fibers are formed into a monolithic catalytically active structure.

32. A catalytically active glass-ceramic produced in accordance with claim 20, wherein said catalyst precursor/glass-ceramic precursor mixture comprises cerium oxide.
